(19) United States
(12) Patent Application Publication
(10) Pub. No.: US 2026/0175615 A1
(43) Pub. Date: Jun. 25, 2026

(54) METHOD FOR PRODUCING AN ARTICLE, A MODULE, AND AN APPARATUS

(71) Applicant: LEONHARD KURZ Stiftung & Co. KG, Fürth (DE)

(72) Inventors: Christiane KRAUSS, Fürth (DE); Martin HAHN, Fürth (DE)

(21) Appl. No.: 18/832,256

(22) PCT Filed: Jan. 23, 2023
(86) PCT No.: PCT/EP2023/051465

§ 371 Date: Jul. 23, 2024

(30) Foreign Application Priority Data
Jan. 28, 2022 (DE) 10 2022 102 052.5

(51) Int. Cl. B44C 1/17; B23K 26/36; B41M 3/12; B41M 5/24; B44C 1/22

(52) U.S. Cl. CPC B44C 1/1729; B23K 26/36; B41M 3/12; B41M 5/24; B44C 1/228

(57) ABSTRACT

A method for producing an article, wherein the method includes the following steps: a) providing a transfer film having a carrier ply and a transfer ply that is detachable from the carrier ply; b) forming at least one first region and at least one second region by means of at least one laser, wherein the layer thickness of the transfer ply in the first region is greater than the layer thickness of the transfer ply in the at least one second region; c) arranging the transfer ply on the substrate; and d) obtaining the article having the transfer ply and the substrate; and wherein the steps of the method are carried out inline. A module for carrying out step b) of the method, including at least one laser for forming the at least one first and second regions. An apparatus for carrying out the method including a module for forming the at least one first and second regions by means of lasers, a transport device or feed device for transporting the transfer film and a device for arranging the transfer ply on the substrate.

The invention relates to a method for producing an article, a module, and an apparatus for carrying out the method.

There is great economic interest in articles which have lettering, motifs and/or symbols, in particular if they can be backlit in the built-in state, with the result that the lettering, motifs and/or symbols are optically recognizable. This type of component part can hereby be used in many sectors, such as for example in the automotive sector or home appliance sector.

Two production variants in particular have become established for the production of these articles. In one common variant, for example, the article is first generated by an injection-molding method and/or by a flooding method. The decoration over the whole surface of the article is effected either by means of an In-Mold Labeling (IML) process, thus during the injection-molding method and/or during the flooding method, or by a decoration process downstream of the injection-molding method or the flooding method, wherein the article surface is in most cases finished over the whole surface. It is not until after the above-named processes that lettering, motifs and/or symbols are introduced into the article, for example by means of lasers or hot stamping, in an additional step. However, a disadvantage of this variant is the large number of method steps and processes needed, which substantially increase the duration of the production of an article.

In a second variant for producing an article, a single image decoration is placed in the cavity of an injection-molding device in an IMD process. This single image decoration already has the complete layout of the article including the lettering, motifs and/or symbols. This second variant is less time-consuming, at least compared with the first-named variant, since fewer method steps are required. However, it is also very costly. Since the single image decorations already comprise all lettering, motifs and/or symbols, their separate production process is complex and has a large number of processes. This has the result that the costs for single image decorations are very high. It is also not possible to adapt the final layout of the article, in particular the lettering, the motifs and/or the symbols, afterwards.

In both of the above-named variants additional costs thus result, which are to be attributed in particular to the large number of process steps and to the decorative product to be used.

The object of the invention now is therefore to provide an improved method for producing an article, as well as a module, and an apparatus for carrying out the method.

The object is achieved by a method for producing an article, in particular according to one of claims 1 to 34, wherein the method comprises the following steps:
a) providing a transfer film comprising a carrier ply and a transfer ply that is detachable from the carrier ply;
b) forming at least one first region and at least one second region by means of at least one laser, wherein the layer thickness of the transfer ply in the at least one first region is smaller than the layer thickness of the transfer ply in the at least one second region;
c) arranging the transfer ply on the substrate;
d) obtaining the article comprising the transfer ply and the substrate; and wherein the steps of the method are carried out inline.

The object is further achieved by a module, in particular according to one of claims 35 to 40, for carrying out step b) of the method according to claim 1 to 34, comprising at least one laser for forming the at least one first and second regions.

Further, the object is achieved by an apparatus for carrying out the method according to claim 1 to 34, in particular according to one of claims 41 to 43, comprising:
a module, in particular according to one of claims 35 to 40, for forming the at least one first and second regions by means of lasers;
a transport device or feed device for transporting the transfer film;
a device for arranging the transfer ply on the substrate, in particular an injection-molding device or hot-stamping device.

It is further possible to provide an article which is produced according to a method according to the invention, preferably according to one of claims 1 to 34, wherein the article comprises the transfer ply arranged on the substrate, wherein the at least one first and second regions are formed in the transfer ply.

By region is meant here in particular in each case a defined surface area of a layer, film or ply which is occupied when viewed perpendicular to a plane formed by the transfer film, in particular by the transfer ply, and/or the substrate. Thus, for example, the at least one transfer ply has at least one first region and an at least second region, wherein each of the two or more regions in each case occupies a defined surface area when viewed perpendicular to a plane formed by the transfer ply, in particular in all layers arranged in the transfer ply and in all layers arranged on top of and/or underneath the transfer ply.

By inline is meant in particular a continuous method in the present case. This means that the articles are produced substantially without interruption, in particular in a constant process. For example, the application of the transfer ply and/or the formation of the at least one first and/or second regions is effected as an integral constituent of the method for producing the article. If a method step for producing the article has been effected, then the subsequent method step follows substantially without interruption, in particular after an infeed of the film or the panel to the device which is used to carry out the next step. The individual steps of the method merge virtually seamlessly into each other, with the result that the transfer ply is arranged on the substrate for example immediately after the formation of the regions. In particular, the film or the panel is shifted or displaced inside the apparatus between the individual steps or substeps and/or devices of the apparatus are shifted and/or displaced between the individual steps or substeps. In particular, no interim storage and/or interim winding or stacking of the film and/or of the transfer ply and/or of the article is effected in the case of an inline method. The method is thus preferably carried out sequentially and without interruptions.

By forming at least one region is meant in the present case in particular the manipulation of the transfer ply, in particular the layers of the transfer ply, wherein the layer thickness of the original transfer ply then differs from that of the manipulated region. The regions are formed in particular in the transfer ply, wherein the layer thickness of the transfer ply is in particular smaller in the manipulated region. It is possible for the at least two regions formed to differ optically. This difference is in particular perceptible for the human eye and/or measurable for a sensor. The formation of the regions is preferably effected by means of laser cutting and/or laser ablation. It is possible for individual layers of the transfer ply to be stripped away and/or ablated and/or combusted and/or evaporated residue-free in the at least one region, in particular a first region. Thus, for example, at least one layer of the transfer ply is completely removed in at least one region, in particular a first region, of the transfer ply, in particular by means of laser cutting and/or laser ablation, with the result that the at least one layer of the transfer ply is and/or has been stripped away residue-free in the one region, in particular first region.

The present method makes it possible to provide transfer films with for example lettering, motifs and/or symbols by means of lasers, immediately before they are arranged on the substrate. This provides several advantages. Thus, because of the use of a laser, it is made possible to generate individual layouts, with the result that only small quantities or even individual pieces can also be generated without additional costs.

Furthermore, last-minute changes in the layout can also be made, such as example to specify the date or time. The decoration can thus be individualized “on demand”. Thus, no decorative films need to be disposed of unused when their layout is no longer current at short notice. Additionally, there is also no need to take structural measures on plant and machines in order to replace layout-specific tools such as for example punching dies. Also, since the method is implemented in one apparatus and within a sequential process, the need for storage and transport of the decorations is reduced at the same time. The above-named advantages in turn lead to cost savings and yet also to a more sustainable and resource-efficient production process.

Furthermore, the material of which the substrate of the article is to consist can be chosen independently of the marking process. Since the laser process is carried out before the transfer ply is arranged on the substrate, the substrate will not interact with the laser radiation. Otherwise, properties of the substrate, such as reflectance, melting point, temperature resistance, could negatively influence or even prevent the production process. A wider range of materials is thus available for the production method. A further advantage of the use of a laser compared with punching and/or cutting is that much more filigreed regions can be formed.

Further advantageous designs of the invention are described in the dependent claims.

Step a) is preferably the first step of the method and is in particular carried out before steps b), c) and d). In step a) it is advantageous for the method that the transfer film is provided in rolls. Further, it is advantageous that a hot-stamping film or an IMD film is provided as transfer film.

It is also advantageous if the apparatus has at least one device for receiving rolls of film. The apparatus preferably has an unrolling device, with which the provided transfer film can be delivered to the method. In particular, the apparatus has at least one control device, in particular for controlling the infeed of the film and the performance of the method steps.

A transfer film provided for the method can have a transfer ply, which is constructed multi-layered. Thus, it has proved to be advantageous that the transfer ply of the transfer film provided in step a) has at least one decorative layer, in particular a first decorative layer, and at least one adhesive layer.

The decorative layer can be formed for example as a colored varnish layer or as a metal layer, in particular as a metallization. The at least one adhesive layer is preferably arranged on the side of the transfer ply facing the carrier ply and/or on the side facing away from the carrier ply. In particular, the adhesive layer is designed transparent, in particular wherein it has a transmittance of at least 45%, preferably of at least 70%, for the wavelength range perceptible by the human eye, preferably for the range from 400 nm to 700 nm. The adhesive layer preferably has a layer thickness selected from a range of from 0.1 μm to 50 μm, preferably from 0.5 μm to 7 μm, further preferably between 2.5 μm and 5 μm. The adhesive layer can be single-layered or multi-layered, wherein the individual sublayers of the adhesive layer can in each case be constituted differently from each other.

Further, the transfer ply can have at least one or more of the following layers, in each case selected individually or in combination from: at least one further decorative layer, at least one colored varnish layer, at least one metal layer, at least one oxide layer, at least one adhesion-promoter layer, at least one barrier layer, at least one acquisition layer, at least one first protective varnish layer, at least one second protective varnish layer, at least one detachment layer, at least one replication layer, at least one laser protective varnish layer. The layers can be arranged in the transfer ply in each case over the whole surface or in each case partially.

The above-named at least one first and/or second protective varnish layer protects the finished article from external influences such as UV radiation, mechanical influences, such as for example scratches, or chemical influences, such as for example creams or solvents, preferably wherein the at least one first and/or second protective varnish layer is arranged between the at least one decorative layer and the carrier ply. Further, the at least one first and/or second protective varnish layer and/or the at least one laser protective varnish layer has in particular a transmittance of at least 70%, preferably of at least 85%, for the wavelength range perceptible by the human eye, preferably for the range from 400 nm to 700 nm. A decoration lying underneath it is hereby clearly recognizable. The at least one laser protective varnish layer in particular prevents a further layer arranged underneath the at least one laser protective varnish layer from being stripped away by means of lasers. For example, the at least one laser protective varnish layer can be arranged between two decorative layers, for example the first and the second decorative layer.

The transfer ply preferably has a layer thickness selected from a range of from 0.1 μm to 100 μm, preferably from 0.5 μm to 75 μm, further preferably from 1 μm to 50 μm. At least one of the layers of the transfer ply, in particular the at least one and/or second decorative layer and/or adhesive layer and/or the at least one and/or second protective varnish layer, preferably has a layer thickness selected from a range of from 0.5 μm to 20 μm, preferably from 1 μm to 10 μm.

The transfer film is preferably provided with a carrier layer made of polyethylene terephthalate (PET) and/or with a detachment layer. The detachment layer is preferably arranged on the side of the carrier layer facing the transfer ply. The carrier ply, preferably the carrier layer, preferably has a layer thickness selected from the range of from 10 μm to 150 μm, preferably from 12 μm to 75 μm.

Step b) is preferably carried out after step a) and in particular before step c). Step b) can also be carried out multiple times, in particular twice. In particular, the at least one first region is formed in step b) such that the transfer ply is removed, preferably is partially removed, in the at least one first region.

It is possible for the at least one first region of the transfer ply to be formed such that fewer layers are arranged in the at least one first region than are arranged in the at least one second region of the transfer ply. Further, it is also possible that after step b) a different layer of the transfer film is perceptible for an observer in the at least one first region than in the at least one second region.

Thus, it is possible for the at least one adhesive layer and optionally the at least one first decorative layer for example to be removed, in particular to be completely removed, in the at least one first region of a transfer ply in step b). The at least one adhesive layer and the optionally at least one first decorative layer are thus no longer perceptible for an observer in the one first region. At least one second decorative layer is advantageously arranged in the transfer ply, which second decorative layer can now be perceived in the at least one first region. It is hereby made possible to create regions which differ from and stand out against each other in terms of their optical properties.

The transfer ply is further preferably completely removed in the at least one first region. In particular, it is possible for the carrier ply of the transfer film to be perceptible in the at least one first region.

A complete removal of the transfer ply provides the advantage that in the article produced the material of the substrate is visible in the at least one first region. The optical properties of the transfer ply and of the substrate advantageously differ here. As a result, interesting designs of the article are made possible in particular because the at least one first region differs from and stands out against the at least one second region.

In particular, the design or shape of the at least one first region is selected individually or in combination from: motif, letter, numeral, symbol, geometric figure, visually recognizable design element, pattern, logo, codes and strip conductor.

Step b) is preferably carried out within a time selected from the range of from 1 s to 90 s, preferably from 1 s to 50 s. The length of time for carrying out step b) is preferably so short that the time required for step b) does not exceed the length of time of the step of the method which requires the longest length of time in order to be carried out. For example, step c) can require a longer length of time in order to be carried out than step b) and/or is the step of the method with the longest length of time.

For carrying out step b) the apparatus according to the invention has in particular a module comprising the at least one laser. The module is preferably designed such that it has at least one feed device in order to transport the transfer film and/or to align it under the laser. For this purpose, the module advantageously has at least one clamping apparatus or a vacuum suction, for fixing the transfer film, and in particular at least one tensioning apparatus for tensioning the transfer film before and/or during step b). The transfer film can hereby be optimally handled and in particular be kept taut and flat.

It is also possible for the module to have a suction device in order to extract, by suction, parts of the transfer ply removed by the laser.

Further, the module preferably has at least one control device, which can preferably be connected to the at least one device which is used to carry out a further step, in particular step c). A synchronization of the step b) carried out by means of the module with the process cycle of the device with which the further step, in particular step c), is carried out is hereby possible.

Further, the module preferably has a quick release apparatus in order to integrate and align the module in the apparatus for carrying out the method reversibly and in several possible positions without a large installation effort and/or expenditure of time. The module comprising the at least one laser is preferably arranged in the apparatus before and/or after the device for arranging the transfer ply on the substrate, in particular in the film infeed direction.

According to the present invention it is possible for at least one third region to be formed by means of the at least one laser in step b). In particular, the at least one third region is formed such that the layer thickness of the transfer ply in the at least one third region is smaller than the layer thickness of the at least one second region. The transfer ply is preferably removed, preferably completely removed, in the at least one third region. Due to the formation of the at least one third region, the transfer ply can be arranged register-accurately in a subsequent step or substep, preferably in step c). In other words, the at least one third region is formed as an auxiliary structure, for example as a register mark. The at least one third region is preferably detected in a further step or substep, in particular in step c), by means of optical sensor units, preferably by means of cameras.

Since the position and type of the third region is not introduced until the step in which the at least one first and second regions are also formed, it can be adapted individually to the desired layout. Furthermore, it is possible that register marks present were already removed during the production of the transfer film or are otherwise no longer usable as an auxiliary structure thereafter, with the result that new register marks have to be generated.

By register-accurate is meant a positional accuracy of two or more plies, elements, regions and/or layers relative to each other. The register accuracy is to range within a predefined tolerance, which is to be as small as possible. At the same time, the register accuracy of several plies, elements, regions and/or layers relative to each other is an important feature in order to increase the process reliability and/or the product quality, but also the protection against forgery. The positionally accurate positioning can be effected in particular by means of sensorily, preferably optically, detectable register marks. These register marks can either represent special separate plies, elements, regions and/or layers or themselves be part of the plies, elements, regions and/or layers to be positioned.

In particular, it is advantageous that the at least one third region is arranged not in contact with the at least one first region. The at least one third region is preferably arranged in the edge region of the transfer film, in particular of the transfer ply. The at least one third region is further preferably arranged on the transfer film, in particular transfer ply, such that the at least one third region is not encompassed by the article obtained.

In particular, at least one laser is used to form the regions, in particular the at least one first, second and/or third regions, wherein the at least one laser is selected from: solid-state laser, preferably fiber laser, YAG laser, UV laser, ruby laser and/or sapphire laser, diode laser, gas laser and/or dye laser. In other words, the apparatus, in particular the module, has at least one laser selected from one of the above lasers.

The use of a laser provides the advantage, in particular over punching tools, that the stripped-away layers of the transfer ply are converted into waste gases in the manipulated regions. This results in a simplified and more convenient disposal. Further, it is also possible to strip away layers in a targeted manner without completely cutting through and/or removing the transfer ply. The layout to be designed is also decisive, in addition to the layer structure of the transfer film and the type of application, for the setting of the laser. For example, the complexity of the layout, thus whether it has large-area and/or filigreed regions, has an influence.

Thus, the size and complexity of the shape of the at least one first region, but also the total size of all first regions, in particular has an influence on the process speed or time required for carrying out step b). The inventors have worked out that the most important parameters for step b) to be carried out cleanly and quickly are selected in particular, alone or in combination, from power of the laser, pulse frequency, deflection speed and control of the machining of the first regions by software.

The at least one laser is advantageously designed such that the at least one laser is operated continuously and/or pulsed.

In particular in the case of a pulsed laser, it is advantageous that the at least one laser is operated at a pulse frequency selected from the range of from 1 Hz to 2,000 kHz, preferably from 1 kHz to 250 kHz. In the case of a pulsed laser, it is advantageous if the pulse frequency at a chosen deflection speed is chosen to be high enough that the regions in which the laser carries out stripping overlap such that a largely closed line or surface area preferably forms and as few gaps as possible form. If the pulse frequency cannot be increased further, then the deflection speed of the laser must be correspondingly adapted in order to achieve such largely closed lines or surface areas.

It is also advantageous that the at least one laser is operated at up to 3,000 characters/s, preferably in the range of from 800 characters/s to 1,500 characters/s. Further, it is possible for the at least one laser, in particular the focus of the at least one laser, to be displaced unidirectionally or bidirectionally in step b). For this purpose, the apparatus, in particular the module, comprising the at least one laser further has a computing unit which calculates the movement direction using software and provides the control signals for moving the laser.

In step b) the distance between two successive laser lines is advantageously selected from a range of from 0.001 mm to 1 mm, preferably from 0.005 mm and 0.5 mm.

At least one first region and/or a region comprising all first regions of up to 500 mm×500 mm, preferably of up to 300 mm×300 mm, can also be formed with the at least one laser.

In step b) it is advantageous if the at least one laser is operated at a deflection speed selected from a range of from 100 mm/s to 10,000 mm/s, preferably from 500 m/s to 3,000 mm/s. The apparatus, in particular the module, comprising the laser preferably has a high-speed laser head. It has been shown that a higher deflection speed than the above-named has a negative effect on the result of the lasering, in particular on the completeness of the layer stripping at depth. The deflection speed thus corresponds to the speed at which the laser is guided over the surface area to be lasered. If it is assumed that the laser is permanently switched on, the deflection speed of the laser then also corresponds to the writing speed of the laser or the stripping speed of the laser.

During the deflection of the laser, the laser can be switched on and off via corresponding control signals in order to define, while it is being guided over the surface area to be lasered, the regions in which the laser carries out stripping and where no stripping is effected. The motif and/or lettering and/or symbol to be stripped away then results from the path of the deflected laser beam and the processes of switching the laser on and off.

In step b) the at least one laser advantageously has a focal length which is selected from 160 mm, 254 mm and/or 420 mm, or is set to one of the above focal lengths. With a larger focal length, the machining range of the laser also increases, since the distance between the objective of the laser and the focal point also increases. As the focal length increases, the beam diameter of the laser likewise increases, whereby the minimally laserable line width and/or the minimally laserable spot diameter is increased. This means that filigreed details in the at least one first and/or second region which, in terms of their dimensions, lie below the minimally possible line thickness and/or below the minimally possible spot diameter are no longer laserable. However, a larger beam diameter is more suitable for two-dimensional stripping, since the laser time for such two-dimensional stripping is thus also reduced.

In particular, it is possible that in step b) the at least one laser has a power selected from the range of from 0.05 W to 100 W, preferably from 1 W to 50 W. A reduction in the time needed for carrying out step b) is reduced by the above-named range of the laser power.

Further, it is possible for the at least one laser to emit coherent light from the infrared range, in particular from the near infrared range, further preferably from the wavelength range of from 200 nm to 1,400 nm, preferably from 780 nm to 1,200 nm, further preferably light with a wavelength of 1,064 nm, and/or to emit coherent light from the UV range, further preferably with a wavelength of from 100 nm to 400 nm, further preferably light with a wavelength of 355 nm.

In particular, in step b) the at least one laser is used with a beam diameter in the focal point of from 20 μm to 150 μm, preferably from 20 μm to 100 μm. The beam diameter determines the minimally laserable line width and/or the minimally laserable spot diameter. Filigreed details in the second region which, in terms of their dimensions, lie above the minimally possible line width and/or below the minimally possible spot diameter can be lasered well with a small beam diameter. However, a larger beam diameter is more suitable for two-dimensional stripping, since the laser time for such two-dimensional stripping is thus also reduced.

Further, it is possible for the at least one laser to comprise a lens system for setting the focal point. In step b) the laser beam of the at least one laser is advantageously widened by means of a lens system such that the beam diameter in the focal point is at most 2 mm, preferably at most 1 mm, particularly preferably at most 0.5 mm.

It is also possible that in step b) the at least one laser comprises deflectable mirrors, in particular a laser scanning module, for directing the laser beam. In particular in step b), the laser beam of the at least one laser is preferably directed over the one or more first and/or third regions of the carrier ply by means of deflectable mirrors, further preferably by means of a laser scanning module.

It is possible for the apparatus, in particular the module, comprising the at least one laser further also to have a cleaning device. This is because gaseous and/or dusty waste gases and smoke result during the formation of the regions using the at least one laser. The resulting contaminants can be removed by means of such a cleaning device before they have a negative influence on further processing, and thus ultimately the quality of the article produced. For this purpose, for example, at least one suction device and/or at least one blower device can be provided. In particular, at least one cleaning device is arranged in the immediate vicinity next to the at least one laser. Further, it can also be advantageous that a cleaning device designed as at least one brush device for removing solid and/or dusty contaminants is provided in the apparatus, in particular in the module, comprising the at least one laser.

In other words, it can be advantageous that the method has the following further step or that step b) and/or step c) comprise the following further substep:
e) cleaning the transfer film, preferably the transfer ply, in particular using at least one brush, a blower and/or a suction device.

Step e) is advantageously carried out before the transfer ply is arranged on the substrate.

An advantage of at least one cleaning unit and a cleaning step is that the transfer ply can be cleaned inline, in particular before the transfer ply is arranged on the substrate. A sufficient quality in the production of the article can hereby be guaranteed without loss of time.

In particular, the method is carried out in process cycles, in particular wherein is a step b) is carried out in the same process cycle as a step c) is carried out in, preferably wherein this step b) and this step c) belong to sequences of steps which are carried out to produce different articles.

By process cycle is meant a time unit of a method in which at least one method step is carried out, in particular wherein the method can have several process cycles and wherein the sequence of the process cycles is alternating. A process cycle preferably has the same length of time. Different process cycles can have a different length of time. It is possible for different method steps, comprising different substeps, to be carried out simultaneously during a process cycle, in particular in a sequential method, preferably in different devices of an apparatus. Thus, for example, a first process cycle can be the infeed of the transfer film in particular to a further machining device or of a module, and a second process cycle can be a method step for producing the article, in particular step b) and/or step c).

In other words, it is possible for step b) to be started for an nth article after or at the same time as step c) is started for an (n+x)th article and for step b) to be ended for an nth article before or at the same time as step c) is ended for an (n+x)th article. Preferably, n and x are selected from the positive integers. Alternatively or additionally, it is also possible for a step b) and a step c) to be started at the same time, wherein a subsequent step is not carried out until the two steps b) and c) started at the same time have been completely finished.

Step c) is preferably carried out after step b) and/or before step d). In particular, step c) can be carried out at least twice. The transfer ply is arranged on the substrate in step c). Here, the transfer ply is preferably arranged on the substrate using a method selected alone or in combination from hot-stamping methods, flooding methods, IMD methods, laminating methods, in-mold labeling (IML) methods, insert-molding methods, print-mold-design (PMD) methods and IMD varioform methods.

In particular, the transfer ply is joined to the substrate over the whole surface or partially, in particular in the at least one second region, after step c) has ended. By joined is meant here that the joined regions, layers, elements and/or planes can no longer be separated from each other non-destructively. For example, this is achieved by an adhesive layer, in particular comprising a hot-melt adhesive.

The method according to the invention provides the advantage that the substrate has to be selected only with regard to the materials of the transfer ply, in particular at least one adhesive layer of the transfer ply, and/or with regard to the suitability of the method chosen in step c). If, for example, an IMD method is chosen in step c), the substrate must be suitable for an injection-molding method. For this purpose, it is at least necessary that the substrate can be melted.

Further, it is possible for the substrate to have a transmittance of at least 45%, preferably of at least 70%, for the wavelength range perceptible by the human eye, preferably for the range from 400 nm to 700 nm. This is advantageous in particular if the transfer ply is arranged on the substrate such that at least one decorative layer is arranged underneath the substrate in the direction of view perpendicular to the plane spanned by the transfer ply. In other words, the substrate faces an observer and the transfer ply is arranged on the side of the substrate facing away from an observer.

According to the invention it is understood that a step can have one or more substeps. Thus, in particular, step c) comprises at least several substeps which are needed in order to carry out the method which is chosen for arranging the transfer ply.

If step c) is, for example, a flooding method, an injection-molding method, for example an IMD method, IML method, insert-molding method, PMD method and/or IMD varioform method, step c) can have, for example, at least one or more of the following substeps:
displacing the transfer ply;
arranging and aligning the transfer ply in the injection mold;
closing the injection mold;
injecting a molten substrate into the injection mold;
waiting time for cooling and solidifying the molten substrate;
opening an injection mold;
removing the article from the mold.

However, if it is a hot-stamping method for example, step c) can have at least one or more of the following substeps:
displacing the transfer film, in particular the transfer ply
providing the substrate;
arranging and aligning the transfer film, in particular the transfer ply, on the substrate;
heating the stamping die
bringing the stamping die into contact in particular with the carrier ply;
displacing the stamping die.

Step c), in particular comprising one or more substeps, is preferably carried out within a time selected from a range of from 1 s to 240 s, preferably from 1 s to 150 s. Further, it is possible for step c) to comprise a waiting time, in particular selected from a range of from 1 s to 60 s, preferably from 1 s to 30 s. By waiting time is meant a time in which no film infeed takes place and/or no substeps of step c) are carried out. This is advantageous in particular if larger first regions are formed in step b). It is hereby possible to continue to carry out a step b) which requires a longer period in the same process cycle as a step c). In particular, the length of time in which step c) is carried out is at least as long as, preferably longer than, the length of time in which step b) is carried out.

In particular, the apparatus, in particular the device for arranging the transfer ply, has at least one sensor unit, in particular an optical sensor unit. This serves to detect the position of at least one marking of the transfer film, in particular of the at least one third region. The sensor unit advantageously comprises at least one transmitted-light and/or reflected-light sensor. A register-accurate arrangement of the transfer film on the substrate is hereby guaranteed.

Depending on the chosen method and the layer structure of the transfer ply, it is possible to remove the carrier ply from the transfer ply in an optional step. The longer the carrier ply remains on the transfer ply, the longer the layout remains protected from physical and/or chemical influences, until it is arranged on the substrate. The protection of the decorated surface is hereby constantly protected from negative effects of the machining methods. The carrier ply is preferably rolled up after being removed from the transfer ply. Alternatively, it is also possible for the carrier ply to remain on the article. This is possible in particular if the transfer ply is transferred from the carrier ply onto the substrate by means of IML methods or laminating. A possibly present detachment layer can remain on the carrier ply or remain on the transfer ply during the removal of the carrier ply. Further, it is also possible for the detachment layer to break up, with the result that after the carrier ply has been removed residues of the detachment layer are arranged on the carrier ply and on the transfer ply.

It can be advantageous if the method has still further steps or substeps. This provides the advantage of producing articles with a more complex structure in sufficient quality and in a short time. For this purpose, the apparatus preferably has further machining devices which are designed such that they are suitable for carrying out the further steps or the further substeps. The at least one further machining device is preferably arranged in the apparatus before and/or after the module comprising the at least one laser, in particular in the film infeed direction. Further, it is also possible for the further machining device to be arranged in the apparatus preferably before and/or after device for arranging the transfer ply on the substrate.

Thus, it can also be advantageous that the method has the following further step.
f) printing on the transfer film, preferably the transfer ply, in particular in at least one first and/or second region preferably selected alone or in combination from inkjet printing, gravure printing, screen printing, flat printing, relief printing and flexographic printing.

In particular, the method can be designed such that step f) is a further substep of step c), or is carried out in the process cycle of a step c). The method is preferably designed such that step f) is carried out before and/or after the transfer ply is arranged on the substrate. The apparatus for carrying out the method preferably has a further device, in particular printing device, for carrying out step f). Further, the printing device preferably has at least one printing mechanism, selected alone or in combination from inkjet printing mechanism, gravure printing mechanism, screen printing mechanism, flat printing mechanism, relief printing mechanism and flexographic printing.

Through a printing, in particular a partial or whole-surface printing, on at least one first and/or second region, this at least one region can be particularly accentuated. The flexibility of the design of the article hereby increases further.

Further, it is also possible for the method to have the following further step or for step c) to comprise the following further substep:
g) pretreating the transfer film, preferably the transfer ply, in particular by means of a method selected alone or in combination from corona treatment, flame treatment and plasma treatment.

In particular, it is advantageous that the apparatus according to the invention has a pretreatment device for pretreating the transfer ply by means of one of the above-named methods. Step g) is advantageously carried out before the transfer ply is arranged on the substrate or the transfer ply is printed on. The quality of a produced article can be further improved by a pretreatment of the transfer film, since a better adhesion to the substrate or a printing ink is hereby made possible.

Furthermore, it is also possible for the method to have the following further step:
h) cutting at least one further region out of the transfer film, preferably out of the transfer ply, by means of punching or waterjet cutting.

The at least one further region can completely or partially overlap with the at least one first and/or second region. Such an additional method step preferably lends itself when a series of articles is produced which have, for example, larger see-through regions, which are in particular arranged identically in each article. Here, the transfer ply is completely removed in particular in the at least one further region. In particular, the apparatus has at least one punching device, in particular for punching the at least one further region out. Step h) is advantageously carried out before and/or after step b) and/or step c) or is a substep of step b) and/or step c).

Further, it is also possible for the method to have the following further step:
i) dividing the transfer film, in particular the transfer ply, into individual panels.

For this purpose, the apparatus for carrying out the method has in particular at least one tailoring device for dividing the transfer film, in particular the transfer ply. Such an above step increases the flexibility of the method according to the invention still further and in particular makes the rapid production of individual panels, such as labels, emblems and/or cards, possible. Step i) is in particular carried out before step c) or after step b). Alternatively, step i) can be carried out in the same process cycle as step c), or can be a substep of step c).

The article produced using the method, which comprises the transfer ply and the substrate, is obtained in step d). Thus, step d) is in particular the last step of the method according to the invention and is carried out after step c) or one of the further optional steps. For this purpose, it is advantageous that the apparatus comprises at least one winding device and/or at least one stacking device for winding and/or stacking the article and/or the carrier ply.

An article produced according to the method according to the invention can be used in a large number of sectors. The article produced can be used with a display and/or with a touchpad and/or with a panel, for example. Further, however, it can also be used as a cover plate and/or as a functional element. In particular, one of the following sectors has proved to be particularly suitable for the use of the article produced: white goods, motor vehicles, aviation, ships, home appliances, telecommunications devices, consumer goods, documents, security elements, labels and/or electronic articles.

It is further possible for the method steps and substeps to be carried out once or multiple times. In particular, method steps and substeps can be repeated. The preferred order of the method steps has at least the sequence of step a)-step b)-step c)-step d), wherein further steps or substeps can in particular be inserted between these steps.

Of course, the above-mentioned characteristics can also be applied in an equivalent way in a method or mentioned method features can also be applied in an equivalent way in the product.

In the following, the invention is explained by way of example with reference to several embodiment examples with the aid of the accompanying drawings. The embodiment examples shown are therefore not to be understood as limitative.

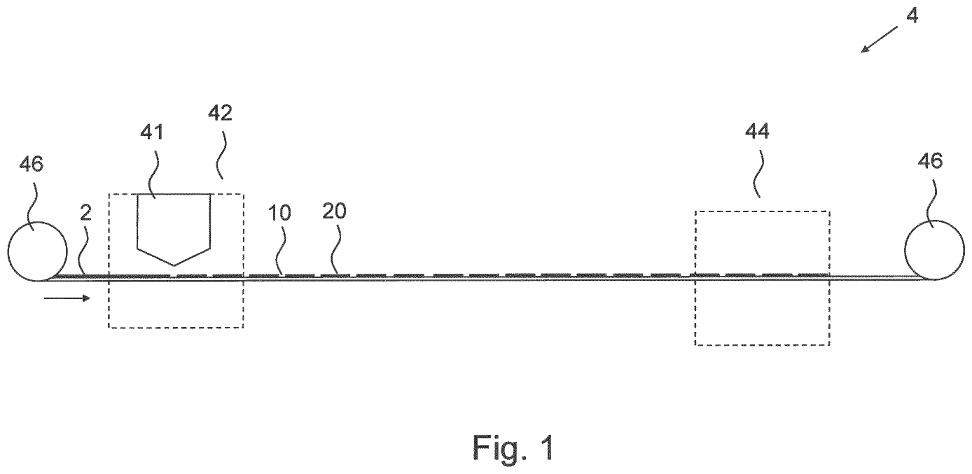

FIG. 1 shows a schematic apparatus for carrying out the method.

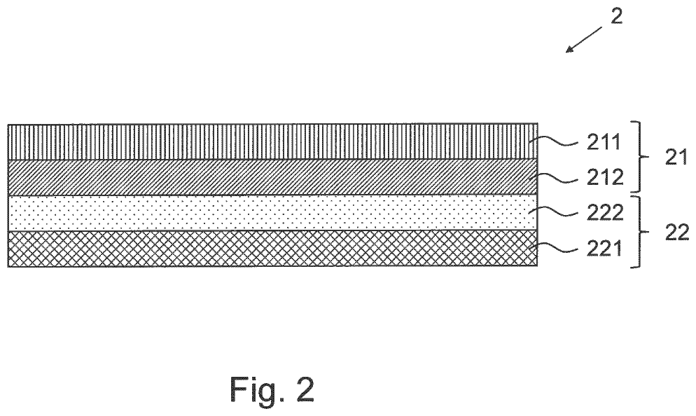

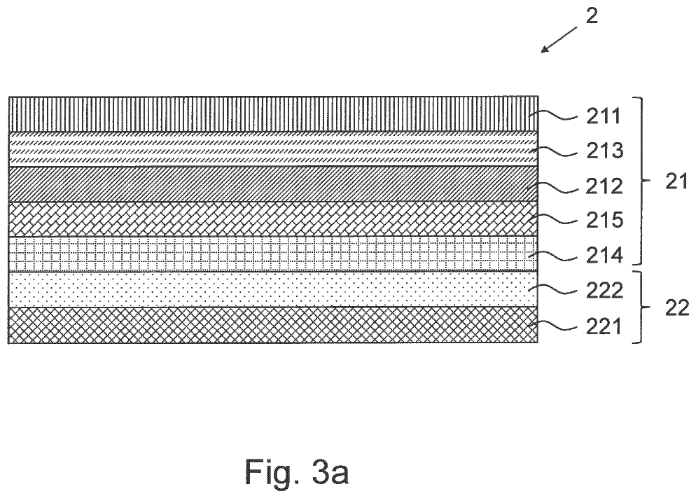

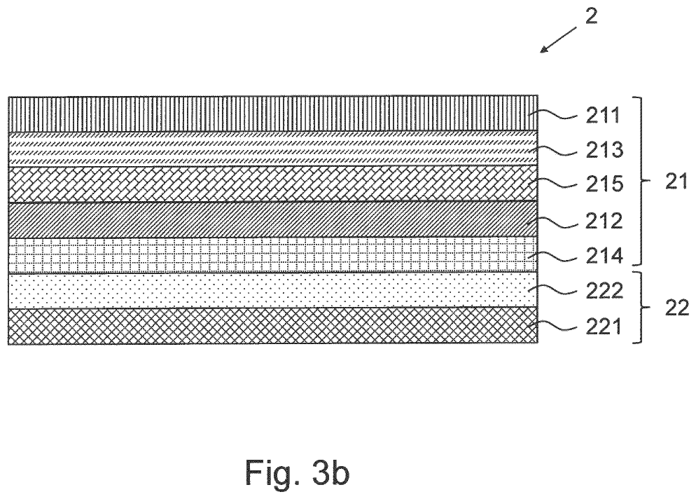

FIGS. 2, 3a and 3b show schematic transfer films for carrying out the method.

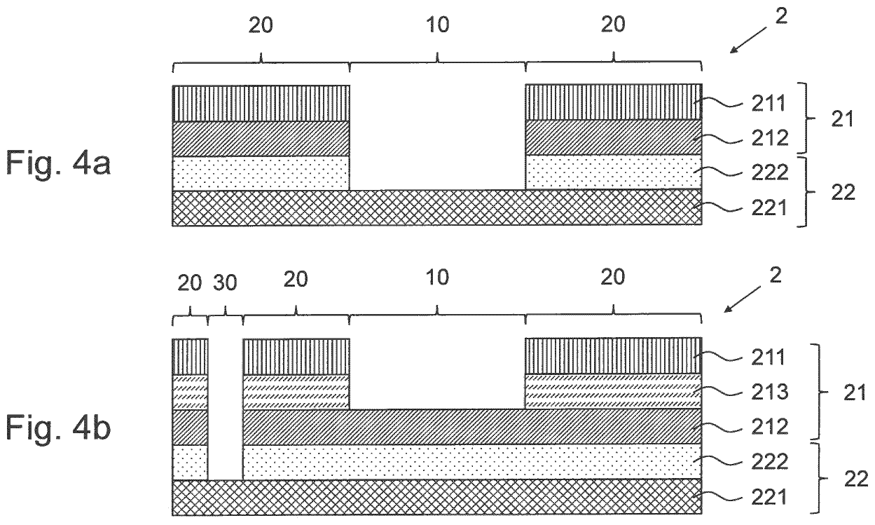

FIGS. 4a and 4b show schematic transfer films with formed regions.

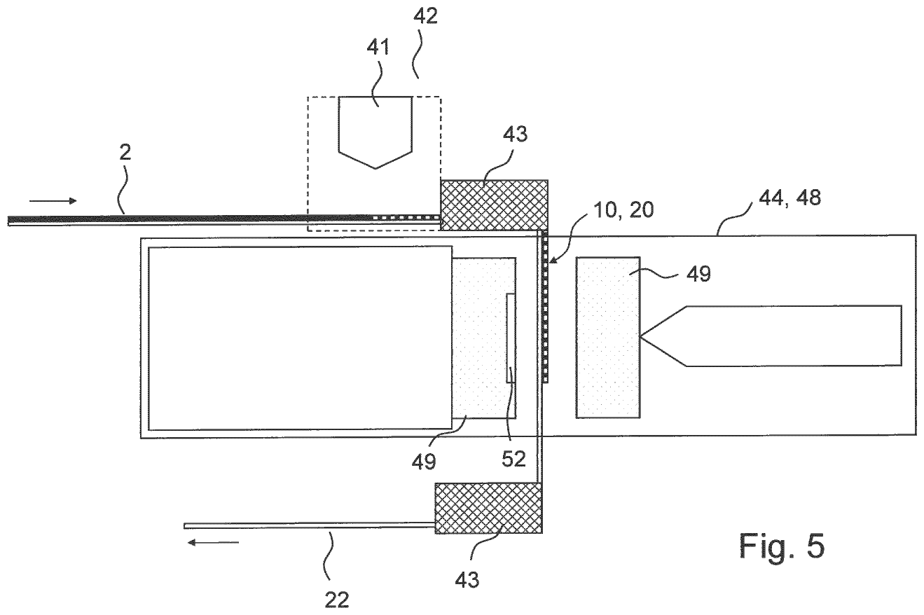

FIG. 5 shows a cutout from a schematic apparatus for carrying out the method.

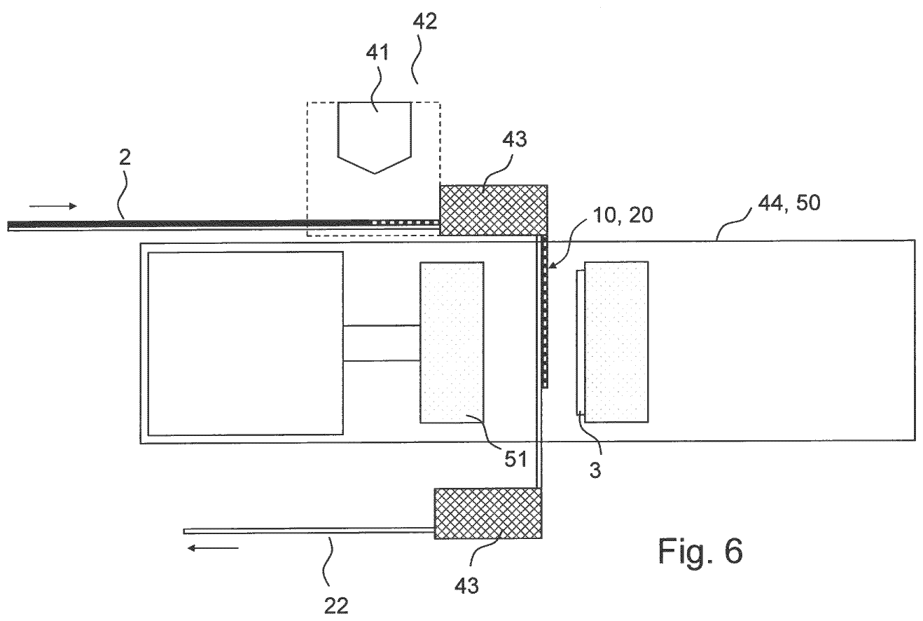

FIG. 6 shows a further cutout from a schematic apparatus for carrying out the method.

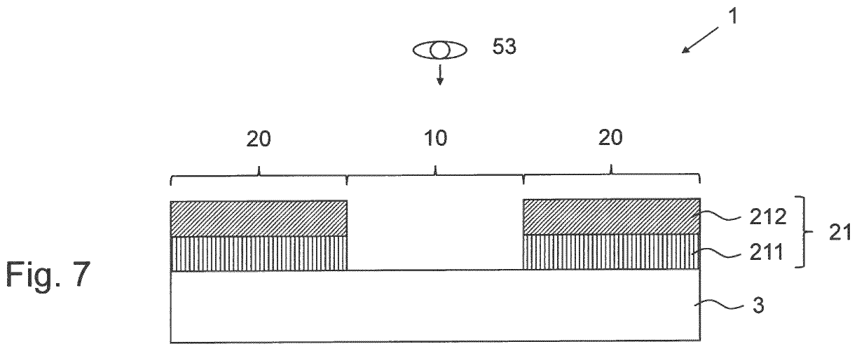

FIG. 7 shows a schematic representation of an article.

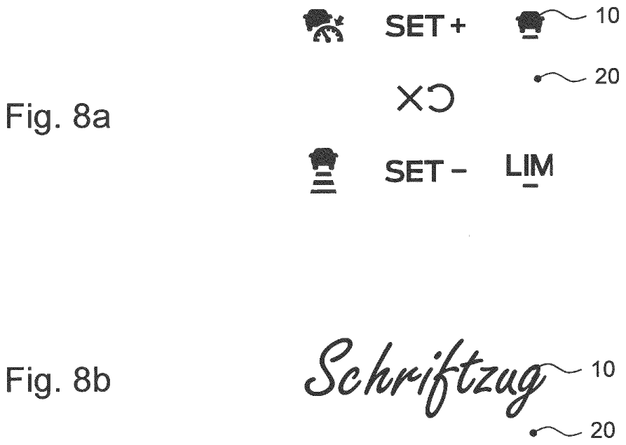

FIGS. 8a and 8b show schematic representations of at least one first and at least one second region in a top view.

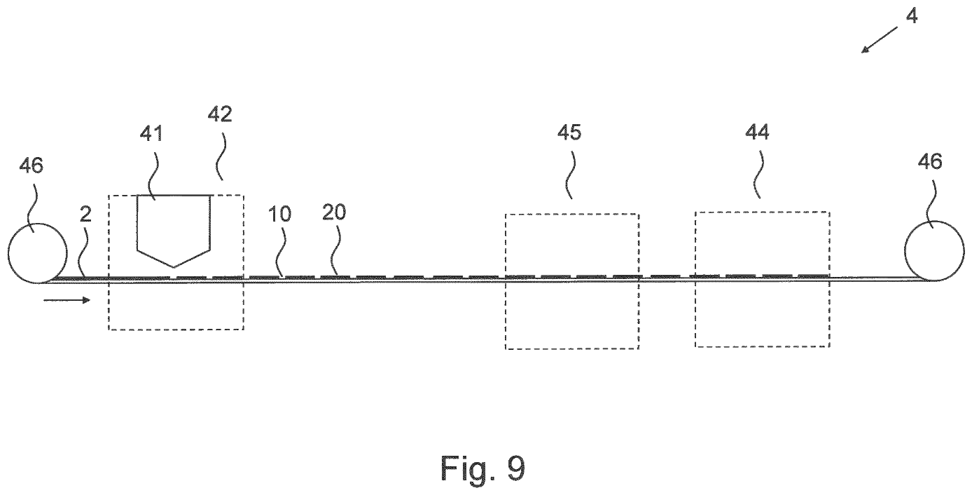

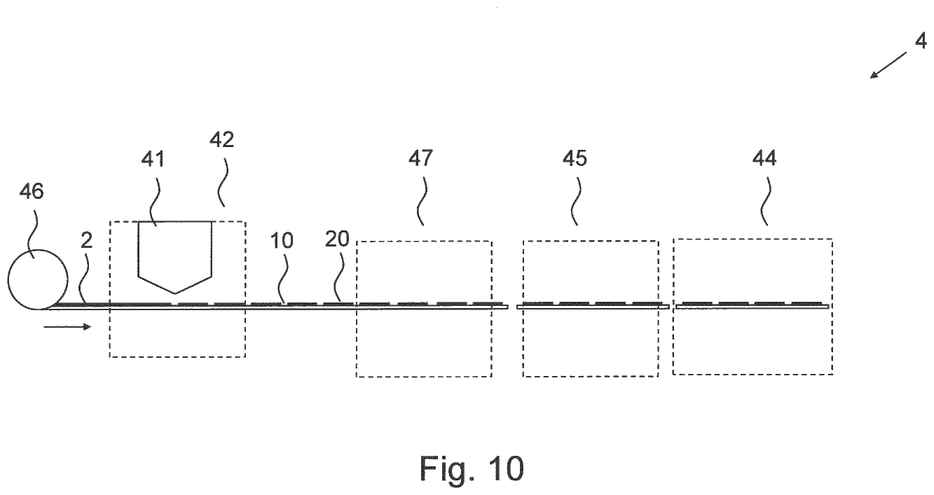

FIGS. 9 and 10 show further schematic apparatuses for carrying out the method.

A schematic apparatus 4 for carrying out a method for producing an article 1 is represented in FIG. 1. The apparatus 4 comprises at least one transport device or at least one feed device 43 for transporting the transfer film 2.

Further, a module 42 for forming the at least one first and second regions 10, 20 is provided in the apparatus 4. This module 42, which is represented schematically by a box with dashed lines in FIG. 1 for the sake of clarity, has at least one laser 41.

Likewise, a device for arranging 44 the transfer ply 21 on the substrate 3 is represented as a box with dashed lines in FIG. 1.

A method for producing an article 1 can be carried out with the apparatus 4 represented in FIG. 1, wherein the method preferably comprises at least the following steps:
a) providing a transfer film 2 comprising a carrier ply 22 and a transfer ply 21 that is detachable from the carrier ply 22;
b) forming at least one first region 10 and at least one second region 20 by means of at least one laser 41, wherein the layer thickness of the transfer ply 21 in the at least one first region 10 is smaller than the layer thickness of the transfer ply 21 in the at least one second region 20;
c) arranging the transfer ply 21 on the substrate 3;
d) obtaining the article 1 comprising the transfer ply 21 and the substrate 3;

In particular, the apparatus 4 or the method is characterized in that the steps of the method are carried out inline. The representation of the apparatus 4 shown in FIG. 1 is chosen by way of example such that the method steps are carried out from left to right. In other words, the arrow drawn in corresponds in each case to the film infeed direction of the transfer film 2 in the following figures. The module 42 comprising the at least one laser 41 is thus provided in the apparatus 4 before the device for arranging the transfer ply 21 on the substrate 3, in particular in the film infeed direction.

The apparatus 4 according to FIG. 1 has at least one device for receiving rolls of film and the transfer film 2 is in particular provided in rolls for the method. For step a) the apparatus 4 further has an unrolling device 46, with which the provided transfer film 2 can be delivered to the method. It is also advantageous that the apparatus 4 has at least one control device, in particular for controlling the infeed of the film and the performance of the method steps, which is not represented here for the sake of clarity.

A transfer film 2, which can be provided for the method in step a), has at least one transfer ply 21 and a carrier ply 22, wherein the transfer ply 21 is detachable from the carrier ply 22. FIG. 2 shows an example of a suitable transfer film 2. This transfer film 2 has in particular a transfer ply 21, which is constructed multi-layered. The transfer ply 21 preferably has at least one decorative layer, in particular a first decorative layer 212, and an adhesive layer 211. The adhesive layer 211 is arranged on the side of the transfer ply 21 facing away from the carrier ply 22.

The decorative layer can be formed for example as a colored varnish layer or as a metal layer, in particular as a metallization. In particular, the adhesive layer 211 is designed transparent, in particular wherein it has a transmittance of at least 70%, preferably of 85%, for the wavelength range perceptible by the human eye, preferably for the range from 400 nm to 700 nm. In particular, it is advantageous if the layer which is to face an observer 53 in the finished article 1 is arranged such that it is in contact with the detachment layer 222.

As an alternative to the arrangement shown in FIG. 2, the adhesive layer 211 can also be arranged on the side of the transfer ply 21 facing the carrier ply 22, wherein this design is not represented here.

The transfer ply 21 preferably has a layer thickness selected from a range of from 0.1 μm to 100 μm, preferably from 0.5 μm to 75 μm, further preferably from 1 μm to 50 μm. At least one of the layers of the transfer ply 21 preferably has a layer thickness selected from a range of from 0.5 μm to 20 μm, preferably from 1 μm to 10 μm. Further, it is advantageous that a hot-stamping film or an IMD film is provided as transfer film 2.

The transfer film 2 represented in FIG. 2 further has a carrier layer 221 made of PET, as well as a detachment layer 222. The detachment layer 222 is preferably arranged on the side of the carrier layer 221 facing the transfer ply 21. The carrier ply 21, preferably the carrier layer 221, preferably has a layer thickness selected from the range of from 10 μm to 150 μm, preferably from 12 μm to 100 μm.

Further, the transfer ply 21 can have at least one or more further layers. As an example, a transfer film 2 which has a carrier ply 22 and a transfer ply 21 that is detachable from the carrier ply 22 is shown in FIG. 3a. The carrier ply 22 is designed like the carrier ply 22 in FIG. 2. The transfer ply 21 of the transfer film 2 shown in FIG. 3a has a first protective varnish layer 214 on the side of the transfer film 2 facing the carrier ply 22. The first protective varnish layer 214 is in particular in contact with a second protective varnish layer 215. A first decorative layer 212 is arranged on the side of the second protective varnish layer 215 facing away from the carrier ply 22, thus on top of the second protective varnish layer 215, wherein a second decorative layer 213 is in turn arranged on top of this. An adhesive layer 211 is in particular arranged on the side of the transfer ply 21 facing away from the carrier ply 22.

Alternatively, it is also possible that, as shown by way of example with in FIG. 3b, at least one protective varnish layer, for example the first or the second protective varnish layer 214, 215, is arranged between the decorative layers 212, 213. Further, it is also possible for a laser protective varnish layer to be arranged between the decorative layers 212, 213. Otherwise the layer structure according to FIG. 3b has the further features of the layer structure according to FIG. 3a.

The transfer film 2, for example according to FIG. 2, 3a or 3b, can also have at least one of the following layers in addition or instead, in each case selected individually or in combination from: at least one further decorative layer, at least one colored varnish layer, at least one metal layer, at least one oxide layer, at least one adhesion-promoter layer, at least one barrier layer, at least one acquisition layer, at least one further protective varnish layer, at least one detachment layer, at least one replication layer and at least one laser protective varnish layer. The layers can be arranged in the transfer ply 21 in each case over the whole surface or in each case partially.

As a specific embodiment example, the protective varnish layer, in particular the at least one first protective varnish layer 214, preferably has a transmittance of more than 85% for the wavelength range perceptible by the human eye, preferably for the range from 400 nm to 700 nm. The layer thickness of the protective varnish layer is preferably selected from the range of from 1.0 μm to 1.5 μm. The protective varnish layer can comprise polyacrylates and preferably contain additives, for example slip additives. Further, particularly preferably at least one decorative layer, in particular the at least one first decorative layer 212 and/or second decorative layer 213, which is designed in particular as a colored varnish layer, preferably has a layer thickness from a range of from 2.2 μm to 2.8 μm and a transmittance of less than 20% for the wavelength range perceptible by the human eye, preferably for the range from 400 nm to 700 nm.

The at least one decorative layer comprises polyacrylates, polyvinyl chloride and/or nitrocellulose. The at least one decorative layer can also preferably contain pigments, in particular with a pigment volume concentration selected from a range of from 0.3 vol.-% to 0.45 vol.-%, in particular with respect to a dried layer.

An adhesive layer 211 preferably has a layer thickness selected from a range of from 0.1 μm to 50 μm, preferably between 0.5 μm and 7 μm, further preferably between 2.5 μm and 5 μm. In particular, the adhesive layer 211 has a transmittance of more than 45% for the wavelength range perceptible by the human eye, preferably for the range from 400 nm to 700 nm. The adhesive layer 211 can comprise pigments, in particular with a pigment volume concentration selected from a range of from 0.2 vol.-% to 0.5 vol.-%, in particular with respect to a dried layer. Further, the adhesive layer 211 can be designed single-layered or multi-layered.

The protective varnish layer can comprise polyacrylate, polyvinyl chloride and/or polyester.

When the method is carried out with the apparatus 1 according to FIG. 1, step b), thus the formation of at least one first region 10, is carried out with the module 42 comprising the at least one laser 41. In particular, step b) can also be carried out at least twice. The formation of regions is preferably effected by means of laser cutting and/or laser ablation. It is possible for individual layers of the transfer ply 21 to be stripped away and/or ablated and/or combusted and/or evaporated residue-free in at least one region, in particular at least in a first region 10. Step b) is preferably carried out before step c) and/or after step a).

Step b) is preferably carried out within a time selected from the range of from 1 s to 90 s, preferably from 1 s to 50 s. The length of time for carrying out step b) is preferably so short that the time required for step b) does not exceed the length of time of the step of the method with the longest required length of time, in particular wherein step c) is the step with the longest length of time of the method.

In particular, the design or shape of the at least one first region 10 is selected individually or in combination from: motif, letter, numeral, symbol, geometric figure, visually recognizable design element, pattern, logo, codes and strip conductor.

The module 42 is preferably designed such that it has at least one feed device 43 in order to transport the transfer film 2 and/or to align it under the laser 41. For this purpose, at least one clamping device or a vacuum suction for fixing the transfer film 2 is advantageously provided in the module 42, and in particular at least one tensioning device for tensioning the transfer film 2 before and/or during step b).

Further, the module 42 preferably has at least one control device, which can preferably be connected to the at least one device which is provided for carrying out a further step, in particular step c). A synchronization of the step b) carried out by means of the module 42 with the process cycle of the device with which the further step, in particular step c), is carried out is hereby possible. Further, the module 42 preferably has a quick release apparatus in order to integrate and align the module 42 in the apparatus 4 for carrying out the method reversibly.

In step b), it is possible for the transfer ply 21 to be completely removed in the at least one first region 10. Such a design of the transfer film 2 is shown by way of example in FIG. 4a.A transfer film 2 according to FIG. 2, which has a carrier ply 22 and a transfer ply 21 that is detachable from the carrier ply 22, is shown there. The carrier ply 22 comprises a carrier layer 221 and a detachment layer 222, which is arranged on the side of the carrier layer 221 facing the transfer ply 21. In the embodiment shown in FIG. 4a the transfer ply 21 is formed by at least one first decorative layer 212 and an adhesive layer 211, wherein the at least one first decorative layer 212 is in contact with the carrier ply 22. In step b) at least one first region 10 and at least one second region 20 are formed by the laser. It is additionally possible for the detachment layer 222 of the carrier ply 22 further also to be removed, in addition to the decorative layer 212 and the adhesive layer 211, in the transfer ply 21 by the laser. It is hereby possible in particular that, as shown in FIG. 4a, the carrier ply 22 of the transfer film 2 is perceptible in the at least one first region 10.

As an alternative to the above embodiment, the at least one first region 10, in which the transfer ply 21 is preferably only partially removed in the at least one first region 10, can, as shown in FIG. 4b, be formed in step b). The transfer film 2 shown in FIG. 4b is designed like the transfer film 2 according to FIG. 1 and additionally also has at least one second decorative layer 213. The at least one second decorative layer 213 is arranged between the at least one first decorative layer 212 and the adhesive layer.

In this embodiment example, the adhesive layer 211 at least one second decorative layer 213 is removed in the at least one first region 10 in step b). A different layer, in particular a different decorative layer, of the transfer film 2 is thus perceptible for an observer 53 in the at least one first region 10 than in the at least one second region 20. In this embodiment example, for an observer 53 the at least one first decorative layer 212 is visible in the at least one first region 10 and the at least one second decorative layer 213 is visible in the at least one second region 20.

Further, the transfer film 2 shown in FIG. 4b additionally has at least one third region 30, which is formed by means of the at least one laser 41 in step b). In particular, the at least one third region 30 is formed such that the layer thickness of the transfer ply 21 in the at least one third region 30 is smaller than the layer thickness of the at least one second region 20. The transfer ply 21 is preferably removed, preferably completely removed, in the at least one third region 30. Due to the formation of the at least one third region 30, the transfer film 2, in particular the transfer ply 21, can be arranged register-accurately in a subsequent step or substep, preferably in step c). In other words, the at least one third region 30 is formed as an auxiliary structure, such as for example a register mark. The at least one third region 30 is preferably detected in a further step or substep, in particular in step c), by means of optical sensor units, preferably cameras.

In particular, it is advantageous that the at least one third region 30 is arranged not in contact in contact with the at least one first region 10. The at least one third region 30 is preferably arranged in the edge region of the transfer film 2, in particular of the transfer ply 21. The at least one third region 30 is further preferably arranged on the transfer film 2, in particular transfer ply 21, such that the at least one third region 30 is not encompassed by the article 1 obtained, for example in which the third region 30 attached to the edge is cut off in a later step.

In particular, at least one laser 41 is used to form the regions, in particular the at least one first, second and/or third regions 10, 20, 30, wherein the at least one laser is selected from: solid-state laser, preferably fiber laser, YAG laser, UV laser, ruby laser and/or sapphire laser, diode laser, gas laser and/or dye laser. In other words, the apparatus 4, in particular the module 42, has at least one laser 41 selected from one of the above lasers 41.

The at least one laser 41 is advantageously designed such that the at least one laser 41 is operated continuously and/or pulsed.

In particular in the case of a pulsed laser, it is advantageous that the at least one laser 41 is operated at a pulse frequency selected from the range of from 1 Hz to 2,000 kHz, preferably between 1 kHz and 250 kHz. In the case of a pulsed laser 41, it is advantageous if the pulse frequency at a chosen deflection speed is chosen to be high enough that the regions in which the laser 41 carries out stripping overlap such that a largely closed line or surface area preferably forms and as few gaps as possible form. If the pulse frequency cannot be increased further, then the deflection speed of the laser 41 must be correspondingly adapted in order to achieve such largely closed lines or surface areas.

It is also advantageous that the at least one laser 41 is operated at up to 3,000 characters/s, preferably in the range of from 800 characters/s to 1,500 characters/s. Further, it is possible for the at least one laser 41, in particular the focus of the at least one laser 41, to be displaced unidirectionally or to be displaced bidirectionally, in particular in directions of travel offset by 90° relative to each other, in step b). For this purpose, the apparatus 4, in particular the module 42, comprising the at least one laser 41 further has a computing unit which calculates the movement direction using software and provides the control signals for moving the laser.

In step b) the distance between two successive laser lines is advantageously selected from a range of from 0.001 mm to 1 mm, preferably from 0.005 mm and 0.5 mm.

At least one first region 10 and/or a region comprising all first regions of up to 500 mm×500 mm, preferably of up to 300 mm×300 mm, can also be formed with the at least one laser 41.

In step b) it is advantageous that the at least one laser 41 is operated at a deflection speed selected from the range of from 100 mm/s to 10,000 mm/s, preferably from 500 m/s to 3,000 mm/s. The apparatus 4, in particular the module 42, comprising the laser 41 preferably has a high-speed laser head. The deflection speed thus corresponds to the speed at which the laser 41 is guided over the surface area to be lasered. If it is assumed that the laser 41 is permanently switched on, the deflection speed of the laser 41 then also corresponds to the writing speed of the laser 41 or the stripping speed of the laser 41.

During the deflection of the laser 41, the laser 41 can be switched on and off via corresponding control signals in order to define, while it is being guided over the surface area to be lasered, the regions in which the laser 41 carries out stripping and where no stripping is effected. The motif and/or lettering and/or symbol to be stripped away then results from the path of the deflected laser beam and the processes of switching the laser 41 on and off.

In step b) the at least one laser 41 advantageously has a focal length which is selected from 160 mm, 254 mm and/or 420 mm, or is set to one of the above focal lengths.

In particular, it is possible that in step b) the at least one laser 41 has a power selected from the range of from 0.05 W to 100 W, preferably from 1 W to 50 W.

Further, it is possible for the at least one laser 41 to emit coherent light from the infrared range, in particular from the near infrared range, further preferably from the wavelength range of from 200 nm to 1,400 nm, preferably from 780 nm to 1,200 nm, further preferably light with a wavelength of 1,064 nm, and/or to emit coherent light from the UV range, further preferably with a wavelength of from 100 nm to 400 nm, further preferably light with a wavelength of 355 nm.

In particular, in step b) the at least one laser 41 is used with a beam diameter in the focal point of from 20 μm to 150 μm, preferably from 20 μm to 100 μm.

Further, it is possible for the at least one laser 41 to comprise a lens system for setting the focal point. In step b) the laser beam of the at least one laser 41 is advantageously widened by means of a lens system such that the beam diameter in the focal point is at most 2 mm, preferably at most 1 mm, particularly preferably at most 0.5 mm.

It is also possible that in step b) the at least one laser 41 comprises deflectable mirrors, in particular a laser scanning module, for directing the laser beam. In particular, in step b) the laser beam of the at least one laser 41 is preferably directed over the one or more first and/or third regions 10, 30 of the carrier ply 22 by means of deflectable mirrors, further preferably by means of a laser scanning module.

The use of a laser 41 provides the advantage, in particular over punching tools, that the stripped-away layers of the transfer ply 21 are converted into waste gases in the manipulated regions. This results in a simplified and more convenient disposal. Further, it is also possible to strip away layers in a targeted manner without completely cutting through or removing the transfer ply 21. The layout to be designed is also decisive, in addition to the layer structure of the transfer film 2 and the type of application, for the setting of the laser 41. For example, the complexity of the layout, thus whether it has large-area and/or filigreed regions, has an influence. Thus, the size and complexity of the shape of the at least one first region 10, but also the total size of all first regions 10, in particular has an influence on the process speed or time required for carrying out step b). In particular, the most important parameters for step b) to be carried out cleanly and quickly are selected in particular, alone or in combination, from power of the laser 41, pulse frequency, deflection speed and control of the machining of the first regions 10 by software.

Thus, the combination of a laser power of 8 watts, a pulse frequency of 50 kHz and a deflection speed of 2,000 m/s has proved to be particularly preferred for example for step b). Further, a twofold stripping, in particular in bidirectional directions of travel offset by 90° relative to each other, preferably with a line spacing of 0.06 mm, can be predefined by the laser software.

It is possible for the apparatus 4, in particular the module 42, comprising the at least one laser 41 further also to have a cleaning device. For this purpose, for example, at least one suction device and/or at least one blower device can be provided. In particular, at least one cleaning device is arranged in the immediate vicinity next to the at least one laser 41. Further, it can also be advantageous that the apparatus 4, in particular the module 42, comprising the at least one laser 41 further has, as cleaning device, at least one brush device for removing solid and/or dusty contaminants.

In other words, it can be advantageous that the method has the following further step or that step b) and/or step c) comprise the following further substep:
e) cleaning the transfer film 2, preferably the transfer ply 21, in particular using at least one brush, a blower and/or a suction device.

It has proved to be advantageous that step e) is carried out before the transfer ply 21 is arranged on the substrate 3.

In particular, the method is carried out in process cycles, in particular wherein a step b) is carried out in the same process cycle as a step c) is carried out in, preferably wherein this step b) and this step c) belong to step sequences which are carried out in order to produce different articles 1.

It is thus possible for different method steps, comprising different substeps, to be carried out at the same time during one process cycle, in particular in a sequential method, preferably in different devices of an apparatus 4. In other words, it is possible for step b) to be started for an nth article 1 after or at the same time as step c) is started for an (n+x)th article 1 and for step b) to be ended for an nth article 1 before or at the same time as step c) is ended for an (n+x)th article (1). Preferably, n and x are selected from the positive integers. Alternatively or additionally, it is also possible for a step b) and a step c) to be started at the same time, wherein a subsequent step is not carried out until the two steps b) and c) started at the same time have been completely finished.

When the method is carried out with the apparatus 4 according to FIG. 1, step c) is carried out with the device for arranging 44 the transfer film 2, in particular the transfer ply 21, on the substrate 3. Step c) is preferably carried out before step d) and/or after step b). In particular, step c) can be carried out at least twice.

The transfer film 2, in particular the transfer ply 21, is arranged on the substrate 3 in step c). Here, the transfer film 2, in particular the transfer ply 21, is preferably arranged on the substrate 3 with a method selected, alone or in combination, from hot-stamping methods, flooding methods, IMD methods, laminating methods, IML methods, insert-molding methods, PMD methods and IMD varioform methods.

In particular, the transfer ply 21 is joined to the substrate 3 over the whole surface or partially, in particular in the at least one second region 20, after step c) has ended.

The method according to the invention provides the advantage that the substrate 3 has to be selected only with regard to the materials of the transfer ply 22, in particular at least one adhesive layer 211 of the transfer ply 22, and/or with regard to the suitability of the method chosen in step c). If, for example, an IMD method is chosen in step c), the substrate 3 must be suitable for an injection-molding method, thus for example be capable of melting. Further, it is possible for the substrate 3 to have a transmittance of at least 45%, preferably of at least 70%, for the wavelength range perceptible by the human eye, preferably for the range from 400 nm to 700 nm. This is advantageous in particular if the transfer ply is arranged on the substrate 3 such that at least one decorative layer is arranged underneath the substrate 3 in the direction of view perpendicular to the plane spanned by the transfer ply 22. In other words, the substrate faces an observer 53.

According to the invention it is understood that a step can have one or more substeps. Thus, in particular, step c) comprises at least several substeps which are needed in order to carry out the method which is chosen for arranging the transfer film 2, in particular the transfer ply 21.

A schematic representation of a device for arranging 44 the transfer film 2, in particular the transfer ply 21, on the substrate 3, such as can be used in an apparatus 4 according to FIG. 1, is shown in FIG. 5, wherein a flooding method and/or an injection-molding method, for example an IMD method, IML method, insert-molding method, PMD method and/or IMD varioform method, is used here.

FIG. 5 shows an injection-molding device 48, comprising an injection mold 49 with at least one cavity 52. The transfer film 2, which was machined beforehand in step b) by means of a module 42 comprising at least one laser 41, has at least one first and one second region 10, 20 in the transfer ply 22. By means of feed devices 43, the transfer film 2 is conducted through the injection-molding device 48, in particular the injection mold 49. In the process, the transfer film 2 is aligned such that the carrier ply 22 faces away from the substrate 3 when the substrate 3 is injected into the injection mold 49.

step c), as represented by way of example in FIG. 5, is a flooding method and/or an injection-molding method, for example an IMD method, IML method, insert-molding method, PMD method and/or IMD varioform method, step c) can have at least one or more of the following substeps for example:
displacing the transfer film 2, in particular the transfer ply 21;
arranging and aligning the transfer film 2, in particular the transfer ply 21, in the injection mold 49, in particular in the at least one cavity 52, such that the carrier ply 22 faces the cavity 52;
closing the injection mold 49;
injecting a molten substrate 3 into the injection mold 49;
waiting time for cooling and solidifying the molten substrate 3;
opening an injection mold 49;
removing the article 1 from the mold.

Alternatively, step c) can also be a hot-stamping method. For illustration, regarding this a corresponding device for arranging 44 the transfer film 2, in particular the transfer ply 21, on the substrate 3, such as can be used in an apparatus 1 according to FIG. 1, is shown schematically in FIG. 6. The transfer film 2 manipulated in step b) by the module 42 comprising at least one laser 41 is conducted through a hot-stamping device 50 by means of feed devices 43 here. The hot-stamping device 50 here has at least one displaceable and heatable stamping die 51. In particular in which the stamping die 51 comes into contact with the transfer film 2, in particular the carrier ply 22, the adhesive layer 211 melts, wherein the transfer ply 21 joins to the substrate 3. The alignment of the apparatus 1 is to be understood as non-limitative here, but merely for illustration purposes. The hot-stamping device 50 is advantageously arranged such that the stamping die 51 can be displaced in the direction of gravity.

A hot-stamping method carried out in step c) can thus have at least one or more of the following substeps:
displacing the transfer film 2;
providing the substrate 3;
arranging and aligning the transfer film 2 on the substrate 3;
heating the stamping die 51;
bringing the stamping die 51 into contact in particular with the carrier ply 22;
displacing the stamping die 51.

Step c), in particular comprising one or more substeps, is preferably carried out within a time selected from the range of from 1 s to 240 s, preferably from 1 s to 150 s. Further, it is possible for step c) to comprise a waiting time, in particular selected from a range of from 1 s to 60 s, preferably from 1 s to 30 s. This is advantageous in particular if larger first regions 10 are formed in step b). It is hereby possible to continue to carry out a step b) which requires a longer period in the same process cycle as a step c).

The apparatus 4 according to FIG. 1 has at least one sensor unit, in particular an optical sensor unit. The sensor unit is preferably comprised by the device for arranging the transfer film 44, for example according to FIG. 2 or FIG. 3, wherein the at least one sensor unit is not represented in the schematic representations for the sake of clarity. The sensor unit serves to detect the position of at least one marking of the transfer film 2, in particular of the at least one third region 30. For this purpose, the sensor unit advantageously comprises at least one transmitted-light and/or a reflected-light sensor.

Depending on the chosen method and the layer structure of the transfer ply 21, it is possible for the carrier ply 22 to be removed from the transfer ply 21 in an optional step. Further, however, it is also possible for the carrier ply 22 not to be peeled off until after step c) and/or for the carrier ply 22 to be removed before step d). The carrier ply 22 is preferably rolled up after being removed from the transfer ply 21, for example by means of a winding device 46. Alternatively, it is also possible for the carrier ply 22 to remain on the article 1. This is possible for example when the transfer ply 21 is arranged on the substrate 3 by means of IML methods. In particular, it is possible for the carrier ply 22 not to be removed until the article 1 is used.

Step d) is preferably the last step of the method. The article 1 produced using the method, which comprises the transfer ply 21 and the substrate 3, is obtained in step d). In FIG. 1 the schematic apparatus 4 has a winding device 46 for this purpose. Alternatively or additionally, it is also possible for the apparatus 4 to comprise at least one winding device 46 for winding the carrier ply 22. Expediently, the winding device 46 is arranged in the apparatus 4 after all other devices in the film-infeed direction.

An article 1 produced according to the method according to the invention can be used in a large number of sectors. The article 1 produced can be used with a display and/or with a touchpad and/or with a panel, for example. Further, however, it can also be used as a cover plate or as a functional element. In particular, the following sectors have proved to be particularly suitable for the use of the article produced: white goods, motor vehicles, aviation, ships, home appliances, telecommunications devices, consumer goods, documents, security elements, labels and/or electronic articles.

A schematic article 1, such as can be produced with the method according to the invention and for example with an apparatus 4 according to FIG. 1, is represented in FIG. 7. The article 1 thus has a transfer ply 21, which is arranged on a substrate 3. The transfer ply 21 is designed by way of example like the transfer ply 21 according to FIG. 2 and thus has at least one first decorative layer 212 and an adhesive layer 211. However, this is not to be understood as limitative, since the transfer ply 21 can, for example, also be designed like the transfer plies 21 in FIG. 3 or FIG. 4b. In the article 1 the adhesive layer 211 of the transfer ply 21 is in contact with the substrate 3, in particular in the at least one second region 20. The at least one first region 10 and the at least one second region 20 are perceptible for an observer 53. Thus, for example, the layers of the transfer ply 21 are visible in the one second region 20, wherein they are completely removed in the at least one first region 10, with the result that the substrate 3 is visible there.

Alternatively, and not represented here, it is also possible that in the case of an article 1 produced by the method according to the invention the layers are arranged such that the substrate 3 faces an observer 53, wherein the substrate 3 has a transmittance of at least 45%, preferably of at least 70%, for the wavelength range perceptible by the human eye, preferably for the range from 400 nm to 700 nm. The substrate 3 is here joined to the transfer ply 21 by the adhesive layer 211, wherein the adhesive layer 211 is in contact with at least one decorative layer. First and second regions 10, 20 are formed at least in the decorative layer. The first and second regions 10, 20 are hereby visible through the substrate 3 and protected against external influences. In the case of the above arrangement of the transfer ply 21 on the substrate 3, at least one first protective varnish layer 214 can preferably be arranged on the side of the transfer ply 21 facing away from the substrate.

First and second regions 10, 20, such as can be formed in step b) of a method and with an apparatus 4 according to FIG. 2, are represented in FIG. 8a and FIG. 8b.

FIG. 8a shows a layout made of a combination of first regions 10 in the form of motifs, letters, symbols, in particular suitable for a user interface of an IMD article. The transfer ply 21 is completely removed in the first regions 10. The size of the first regions 10 here is between 8 mm×8 mm and 22 mm×6 mm. The size of the entire layout, thus the region over which the at least one laser 41 is displaced is 50 mm×70 mm. The layout was formed with a power of 6 W, a speed of 1,500 mm/s and a frequency of 20 kHz in a time of 15.44 s. This time is shorter than the time which is required for a step c), in particular for all substeps of step c). In other words, this time is shorter than the time which a process cycle of a step c) comprises. As step c), for example, an injection-molding method is chosen here, the duration of which in the case of this article 1 is approx. 25 s, in particular 25 s. A step b) can thus be integrated in the process cycle of a step c) without additional expenditure of time.

FIG. 8b shows first regions 10, which are designed in particular as curved letters, which produce lettering. The lettering is 22.8 mm×7.68 mm in size. The first regions 10 are in particular 1 mm to 1.5 mm wide. The lettering is formed in a transfer film 2, in particular a hot-stamping film, with a power of 4 W, a speed of 1,500 mm/s and a frequency of 20 kHz in a time of 1.5 s. A stamping process is preferably carried out in step c), wherein a time of approx. 3 s, in particular 3 s, is required for this. Step b) is thus able to be integrated in the process cycle of step c) without trouble.

A further embodiment example of an apparatus 4 for carrying out the method according to the invention is represented schematically in FIG. 9. The apparatus 4 is based on the apparatus 4 according to FIG. 1 and has the devices and features thereof. At least one further machining device 45 is additionally provided in the apparatus 4. With this at least one further machining device 45, further method steps, in particular at least in addition to steps a) to d), can be integrated in the method. The at least one further machining device 45 is provided in the apparatus before and/or after the module 42 comprising the at least one laser 41 and/or the device for arranging the transfer ply 44 on the substrate 3, in particular in the film infeed direction.

Thus, it can also be advantageous that the method has the following further step.
f) printing on the transfer film 2, preferably the transfer ply 21, in particular in at least one first and/or second region 10, 20 preferably selected alone or in combination from inkjet printing, gravure printing, screen printing, flat printing, relief printing and flexographic printing.

In particular, the method can be designed such that step f) is a further substep of step c), or is carried out in the process cycle of a step c). The method is preferably designed such that step f) is carried out before and/or after the transfer ply 21 is arranged on the substrate 3. The apparatus 4 for carrying out the method thus has at least one further machining device 45, which is designed as in particular as a printing device for carrying out step f). Further, the printing device preferably has at least one printing mechanism selected, alone or in combination, from inkjet printing mechanism, gravure printing mechanism, screen printing mechanism, flat printing mechanism, relief printing mechanism and flexographic printing mechanism.

Further, it is also possible for the method to have the following further step or for step c) to comprise the following further substep:
g) pretreating the transfer film 2, preferably the transfer ply 21, in particular by means of a method selected alone or in combination from corona treatment, flame treatment and plasma treatment.

In particular, it is advantageous that the apparatus 4 has a further machining device 45 in the form of a pretreatment device for pretreating the transfer ply 21. Step g) is advantageously carried out before the transfer ply 21 is arranged on the substrate 3 or the transfer ply 21 is printed on.

Furthermore, it is also possible for the method to have the following further step:
h) cutting at least one further region out of the transfer film 2, preferably out of the transfer ply 21, by means of punching or waterjet cutting.

The at least one further region can completely or partially overlap with the at least one first and/or second region 10, 20. In particular, the transfer ply 21 is completely removed in the at least one further region. In particular, the at least one further machining device here is preferably provided as a punching device. Step h) is advantageously carried out before and/or after step b) and/or step c) or is a substep of step b) and/or step c).

A further embodiment example of an apparatus 4 for carrying out the method is represented schematically in FIG. 10. The apparatus 4 according to FIG. 10 has in particular the devices and features of the apparatus according to FIG. 1. It also comprises the at least one further machining device 45, such as is described in the embodiment example according to FIG. 9. In addition to the apparatuses already described in FIG. 1 or FIG. 9, this embodiment example further also has a further machining device 45, which is designed as a tailoring device 47 for dividing the transfer film 2, in particular the transfer ply 21. This tailoring device 47 is provided in the apparatus 2 after the module 42 comprising the at least one laser 41, in particular in the film infeed direction. Further, the tailoring device 47 is arranged in the apparatus 4 before the further machining devices 45 and/or the device for arranging 44 the transfer film 2 on the substrate 3, in particular in the film infeed direction.

Through this tailoring device 47, it is possible for the method to have the following further step, in particular at least in addition to steps a) to d):
i) dividing the transfer film 2, in particular the transfer ply 21, into individual panels.

Step i) is in particular carried out before step c) or after step b). Alternatively, step i) can be carried out in the same process cycle as step c), or be a substep of step c). For example, the at least one third region 30 can be removed by step i). In particular, the apparatus according to FIG. 10 has a stacking device for stacking the article 1. This stacking device is arranged in the apparatus after all other devices, preferably in the film infeed direction.

Of course, the above-listed embodiment variants of the apparatuses, devices, methods or method steps can be combined with each other as desired and do not represent a limitation, in particular in terms of the shaping and combination thereof.

### LIST OF REFERENCE NUMBERS

1 article
2 transfer film
3 substrate
4 apparatus
21 transfer ply
22 carrier ply
10 first region
20 second region
30 third region
211 adhesive layer
212 first decorative layer
213 second decorative layer
214 first protective varnish layer
215 second protective varnish layer
221 carrier layer
222 detachment layer
41 laser
42 module
43 feed device
44 device for arranging
45 further machining device
46 unrolling/winding device
47 tailoring device
48 injection-molding device
49 injection mold
50 hot-stamping device
51 stamping die
52 cavity
53 observer

1. A method for producing an article wherein the method comprises the following steps:
a) providing a transfer film comprising a carrier ply and a transfer ply that is detachable from the carrier ply;
b) forming at least one first region and at least one second region by means of at least one laser, wherein the layer thickness of the transfer ply in the at least one first region is smaller than the layer thickness of the transfer ply in the at least one second region;
c) arranging the transfer ply on the substrate;
d) obtaining the article comprising the transfer ply and the substrate;
and wherein the steps of the method are carried out inline.

2. The method according to claim 1, wherein
the method is carried out sequentially and without interruptions and/or wherein the method is carried out continuously.

3. The method according to claims, claim 1, wherein
the method is carried out in process cycles.

4. The method according to claim 3, wherein
a step b) is carried out in the same process cycle in which a step c) is carried out.

5. The method according to claim 3, wherein
an infeed of the transfer film is carried out in a first process cycle and a step is carried out in a second process cycle.

6. The method according to claim 1, wherein
step b) is started for an nth article after or at the same time as step c) is started for an (n+x)th article and wherein step b) is ended for an nth article before or at the same time as step c) is ended for an (n+x)th article.

7. The method according to claim 1, wherein
at least one third region is formed in step b) by means of the at least one laser, such that the layer thickness of the transfer ply in at least one third region is smaller than the layer thickness of the at least one second region.

8. The method according to claim 7, wherein
the transfer ply is arranged register-accurately in step c) by means of the at least one third region.

9. The method according to claim 7, wherein
the at least one third region is arranged in the edge region of the transfer film.

10. The method according to claim 7, wherein
the at least one third region is arranged not in contact with the at least one first region.

11. The method according to claim 7, wherein
the at least one third region is detected in a further step or substep, by means of optical sensor units.

12. The method according to claim 1, wherein
the at least one first region is formed in step b) such that the transfer ply is removed, in the at least one first region.

13. The method according to claim 1, wherein
the at least one first region of the transfer ply is formed such that fewer layers are arranged in the at least one first region of the transfer ply than are arranged in the at least one second region of the transfer ply.

14. The method according to claim 1, wherein
a hot-stamping film or an IMD film is provided as transfer film.

15. The method according to claim 1, wherein
the transfer film is provided in rolls.

16. The method according to claim 1, wherein
the design or shape of the at least one first region is selected individually or in combination from motif, letter, numeral, symbol, geometric figure, visually recognizable design element, pattern, logo, code and strip conductor.

17-19. (canceled)

20. The method according to claim 1, wherein
in step b) the distance between two successive laser lines is selected from a range of from 0.001 mm to 1 mm, and/or wherein at least one first region of up to 500 mm×500 mm is formed by the at least one laser.

21. The method according to claim 1, wherein
in step b) the at least one laser is operated at a deflection speed selected from the range of from 100 mm/s to 10,000 mm/s, and/or wherein the at least one laser is operated at a pulse frequency selected from the range of from 1 Hz to 2,000 kHz, and/or wherein the at least one laser is operated at up to 3,000 lines/s.

22-24. (canceled)

25. The method according to claim 1, wherein
in step b) the at least one laser is used with a beam diameter in the focal point of from 20 μm to 150 μm.

26. The method according to one claim 1, wherein
in step b) the laser beam of the at least one laser is widened by means of a lens system such that the beam diameter in the focal point is at most 2 mm.

27. (canceled)

28. The method according to claim 1, wherein
in step c) the transfer ply is arranged on the substrate with a method selected, alone or in combination, from hot-stamping methods, flooding methods, IMD methods, laminating methods, IML methods, insert-molding methods, PMD methods and IMD varioform methods.

29. The method according claim 1, wherein
the method has the following further step or wherein step b) and/or step c) comprises the following further substep:
e) cleaning the transfer film.

30. The method according to claim 1, wherein
the method has the following further step or wherein step c) comprises the following further substep:
f) printing on the transfer film.

31. The method according to claim 1, wherein
the method has the following further step or wherein step c) comprises the following further substep:
g) pretreating the transfer film.

32. The method according to claim 1, wherein
the method has the following further step or wherein step c) comprises the following further substep:
h) cutting at least one further region out of the transfer film by means of punching or waterjet cutting.

33. The method according to claim 1, wherein
the method has the following further step or wherein step c) comprises the following further substep:
i) dividing the transfer film into individual panels.

34. The method according to claim 1, wherein
the article obtained in step e) is selected from the group: display, touchpad, panel, cover plate, functional element.

35. A module for carrying out step b) of the method according to claim 1, comprising at least one laser for forming the at least one first and second regions.

36. The module according to claim 35, wherein
the module has at least one control device, for synchronizing with further devices, in and/or with the process cycle of the further method steps.

37. The module according to claim 35, wherein
the module has a quick release apparatus, for reversible integration and alignment in an apparatus for carrying out the method.

38. The module according to claim 35, wherein
the module has at least one clamping apparatus or a vacuum suction for fixing the transfer film.

39. The module according to claim 35, wherein
the module has at least one feed device in order to transport the transfer film and/or to align it under the laser.

40. The module according to claim 35, wherein
the module has at least one tensioning apparatus for tensioning the transfer film before and/or during step b).

41. An apparatus for carrying out the method according to claim 1, comprising:
a module for forming the at least one first and second regions by means of lasers;
a transport device or feed device for transporting the transfer film;
a device for arranging the transfer ply on the substrate.

42. The apparatus according to claim 41, wherein
the apparatus is suitable for a continuous method.

43. The apparatus according to claim 41, wherein
the apparatus further has one or more of the following devices:
at least one pretreatment device for pretreating the transfer ply;
at least one suction device for extracting gaseous and/or dusty waste gases by suction;
at least one blower device for blowing gaseous and/or dusty waste gases away;
at least one brush device for removing solid contaminants;
at least one tailoring device for dividing the transfer film;
at least one punching device.

44. The apparatus according to claim 41, wherein
the apparatus further has one or more of the following units or devices:
at least one sensor unit for detecting the position of at least one marking of the transfer film, comprising at least one transmitted-light and/or reflected-light sensor;
at least one device for receiving rolls of film;
at least one control device;
at least one winding device and/or at least one stacking device for winding and/or stacking the article and/or the carrier ply.
